(19) United States
(12) Patent Application Publication
(10) Pub. No.: US 2013/0036024 A1
(43) Pub. Date: Feb. 7, 2013

(54) SYSTEMS AND METHODS FOR ONLINE PRE-PURCHASE VISUAL BUNDLING

(71) Applicant: Edward George Boettcher, Santa Barbara, CA (US)

(72) Inventor: Edward George Boettcher, Santa Barbara, CA (US)

(21) Appl. No.: 13/564,680

(22) Filed: Aug. 1, 2012

Related U.S. Application Data
(60) Provisional application No. 61/514,476, filed on Aug. 2, 2011.

(51) Int. Cl. G06Q 30/06

(52) U.S. Cl. 705/26.8

(57) ABSTRACT

Methods for online pre-purchase visual bundling including a “builder” that combines a pre-defined image window matrix (a.k.a. “matrix”), scrolling textual list (a.k.a. “list”, selection panel, cart snapshot and control bar for building, editing, saving, sharing, printing and purchasing the bundle, for relating the bundle to a material world appositional analogue by predefining an image window designation to an image and/or additionally a proportional analogue, providing an “above the fold” visualization with the matrix combined with the list, for switching items from the list to the matrix, for linking multiple “builders” via a singular key, for moving or removing the item to the shopping cart snapshot and removing the item from the builder window from the matrix or the list, and for adding a predefined bundle to the matrix and the list with a number of predefined item bundles from a submenu of the selection panel.

### CROSS REFERENCE TO RELATED APPLICATION

This application claims the benefit of U.S. application 61/514,476, filed Aug. 2, 2011, and is incorporated by reference herein

### FIELD OF INVENTION

The systems and methods described herein relate generally to the field of electronic commerce and more specifically to online pre-purchase visual bundling.

### BACKGROUND

The online e-commerce purchase method and process has evolved and settled into a moderately standard process (Aliabadi et al. U.S. Pat. No. 7,412,409, 2008) where one or many items can be selected from a variety of menu configurations and on the click of a button an item is loaded from one or many back-end databases into a virtual shopping cart that contains functionality for the user to proceed to a checkout process for adding the necessary shipping and payment fields. In common usage with the purchase process is a pre-purchase process (a.k.a. a “wish list” process) where the user can add, remove and save one or many items for later addition into the cart for example (http://www.bhphotovideo.com) and (http://www.adorama.com/). To support the pre-purchase and purchase process a method is employed where a web page has page display elements that connect dynamically to a back-end database that stores product information, product images, pricing, product descriptions, etc. Many different types of database schemas and programming languages can be employed to fulfill this process.

The current state of the art for the pre-purchase “wish list” display method is generally the same display method as the purchase process shopping cart, where selected items are listed in a multi-row format, sometimes with an image in the row of the item and sometimes with the ability to allow public access to the entire wish list via a URL or e-mail. Generally at some point of product addition into the wish list, the list will extend below the visible portion of the screen (a.k.a. “below the fold” of the screen), particularly for low screen resolution users (800×600), users with a 16×9 aspect ratio monitor, or users with large browser magnification in place. Rows are generally sorted with the most recent addition at the top of the list, the second most recent addition below that, etc.

While the current state of the art of pre-purchase item is in common use, it does not lend itself to the bundling of items that are related in use and proximity in the material world to complete a desired process. For example a filmmaker will often use a camera, a lens with a matte box attachment, a tripod and a stage light together to film a scene. In the material world the lens is attached to the front of the camera and the lens and camera are placed on top of a tripod. To the side of the camera rig is the light for lighting the scene. Additionally, these items have different proportional relationships (e.g. a camera is generally compact and rectangular, a tripod is tall and rectangular and a soft box used to diffuse the light transmission for a stage light is large and square.) It is of great benefit to the user when building a bundle of items that are related in use to achieve a desired process to pre-visualize the purchase with a method that displays the images of the items analogous to their proximity of use in a material world application in one field of reference. Additionally items whose images are photographed with standardization of proportion can be displayed together to pre-visualize their proportional relationship to each other. This is analogous to an archeologist that places a pencil or a ruler next to an object when photographing the object to relate to the viewer the proportion of the object.

### SUMMARY

The systems and methods of the present invention improves upon the current state of the art by providing for the ability to build or select a bundle of goods in a pre-purchase environment with visualization to a material world analog in one field of reference (a.k.a. “the builder”.) By using an image window matrix combined with a scrolling textual list a user will be able to switch items in and out of the image window matrix “above the fold” of the screen for a typical user. By combining an expanding selection window, a user will be able to select items for addition into the builder window. By including a control bar a user will be able to save, edit, share, print and add to the shopping cart snapshot the entire bundle of goods. By using additional table cells adjacent to the image windows, or layers adjacent to the images, buttons and a dynamic price fields can be provided to the user with the ability to remove items from the builder, add items to the shopping cart snapshot, remove items from the snapshot and view the current price prior to adding to the shopping cart snapshot. By including a checkout button a user will be able to move the shopping cart snapshot items to the checkout tool for purchase. By using nested tables in the code the user can be provided with differently proportioned windows (e.g. a tall, narrow window for a tripod and a large square window for a light soft box.) By sharing a single bundle key, multiple bundles can be related across multiple pages of bundle categories. A user could then employ a page for building production bundles and a page for building post-production bundles joined across the pages by the single identifying key, thus creating a superset of production and post-production items (a.k.a. “a rig”). All of these elements taken together essentially “miniaturize” the pre-purchase bundle visualization and functionality and offer a significant improvement for the user's pre-purchase experience.

The primary object of the invention is to provide an improved online e-commerce pre-purchase “wish list” (a.k.a. “the builder) that combines a pre-defined image window matrix, a scrolling textual list, an expanding selection panel, a cart snapshot and a control bar for building, editing, saving, sharing, printing and ultimately purchasing a bundle of items.

Another object of the invention is to provide an online pre-purchase visual bundling tool that provides the ability for images to be displayed appositional analogous to a material world application that typically requires a bundle of items to be performed allowing the user a better opportunity to pre-visualize the bundle prior to purchase.

Another object of the invention is to provide a variant of the online pre-purchase visual bundling tool that provides the ability for images to be displayed proportionally to their material world analogues allowing the user a better opportunity to pre-visualize the bundle contents proportion in relationship to each other prior to purchase.

A further object of the invention is to provide an improved means for a user to add or remove items to and from the pre-purchase visual bundling tool and to and from the shopping cart snapshot while optimizing use of the typical visible area (“above the fold”) of a web page.

Yet another object of the invention is to provide an online pre-purchase bundling tool with a user interface that allows for a user to switch items from a scrolling textual list to the image windows thus allowing for a number of items to be visualized on one entirely visible field of reference (“above the fold”) of a web page.

Still yet another object of the invention is to provide an online pre-purchase bundling tool with a common key that allows multiple builders to be related to each other (e.g. a filmmaker production bundle containing cameras, lenses and lighting and a post-production bundle containing an editing computer, software, editing keyboard and monitor.)

Another object of the invention is to provide an online pre-purchase bundling tool that can be populated with a number of predefined item bundles from a submenu of the selection panel.

Yet another object of the invention is to provide a online pre-purchase bundling tool with additional table cells adjacent to the image windows or layers adjacent to the images, with buttons and a dynamic price fields to provide the user with the ability to remove items from the builder, add items to the shopping cart snapshot, remove items from the snapshot and view the current price prior to adding to the shopping cart snapshot.

Still yet another object of the invention is to provide a checkout button to enable the user to be able to move the shopping cart snapshot items to the shopping cart for purchase.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is a system and method for online pre-purchase visual bundling comprising the steps of: providing an improved online e-commerce pre-purchase “wish list” (a.k.a. “the builder”) that combines a pre-defined image window matrix, a scrolling textual list, an expanding selection panel, a cart snapshot and a control bar for building, editing, saving, sharing, printing and ultimately purchasing a bundle of items, means for relating the pre-purchase bundle to a material world appositional analogue by predefining an image window designation to an image, providing an “above the fold” visualization of a bundle of goods by providing a positional image window matrix combined with a scrolling textual list, means for switching items from the scrolling textual list to the image window matrix, means for linking multiple “builders” via a singular key, means for moving the item to the shopping cart snapshot, removing the item from the shopping cart snapshot and removing the item from the builder image window matrix, means for moving the item to the shopping cart snapshot, removing the item from the shopping cart snapshot and removing the item from the from the scrolling text list, and means for adding a predefined bundle to the image window matrix and the scrolling text list with a number of predefined item bundles from a submenu of the selection panel.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIGS. 1A.-1D. are database diagrams of the embodied back-end database tables and fields of the invention.

FIG. 2. is a simplified plan view of the invention with an appositional window image matrix.

FIG. 3. is an simplified exploded view of the invention.

FIG. 4A. is a detailed plan view of the “control bar” invention component.

FIG. 4B. is a detailed plan view of the “image window matrix” component of the invention.

FIG. 4C. is a detailed plan view of the “additional builder items” component of the invention.

FIG. 4D. is a detailed plan view of the “selection panel” component of the invention.

FIG. 4E. is a detailed plan view of the “cart snapshot” component of the invention.

FIG. 5. is an illustration of a typical material world application analogous to the appositional image window matrix of the invention.

FIG. 6A. is a detailed plan view of the “image window matrix” invention component populated with images that are a subset of FIG. 5.

FIG. 6B. is a detailed plan view of the “additional builder items” invention component populated with a product name of an additional item.

FIG. 7. is a plan view of the invention with an appositional image window matrix and a proportional image window matrix variation populated with images from FIG. 5.

FIG. 8. is an illustration of an expanding menu for adding an entire pre-configured bundle (a.k.a. “rig”) to the builder(s) or the cart snapshot.

FIG. 9A. is an illustration of an expanding menu for adding a single item from a category to the builder or the cart snapshot, and an associated quantity input pop up box.

FIG. 9B. is an illustration of a quantity input pop up box associated to the expanding menu found in FIG. 9A. or associated to any other “add to cart” button.

FIG. 10. is an overview flow diagram consisting of a simplified representation of two builders joined by a single key where the additional builder items component of the invention is populated with a filtered data set from the AdditionalItems table.

### DETAILED DESCRIPTION

Exemplary embodiments of the present systems and methods of the present invention will now be described with reference to the accompanying drawings and figures. These exemplary embodiments are described in sufficient detail to reveal the best mode of implementing the invention, and to enable those skilled in the art to practice the invention. It should be understood, however, that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

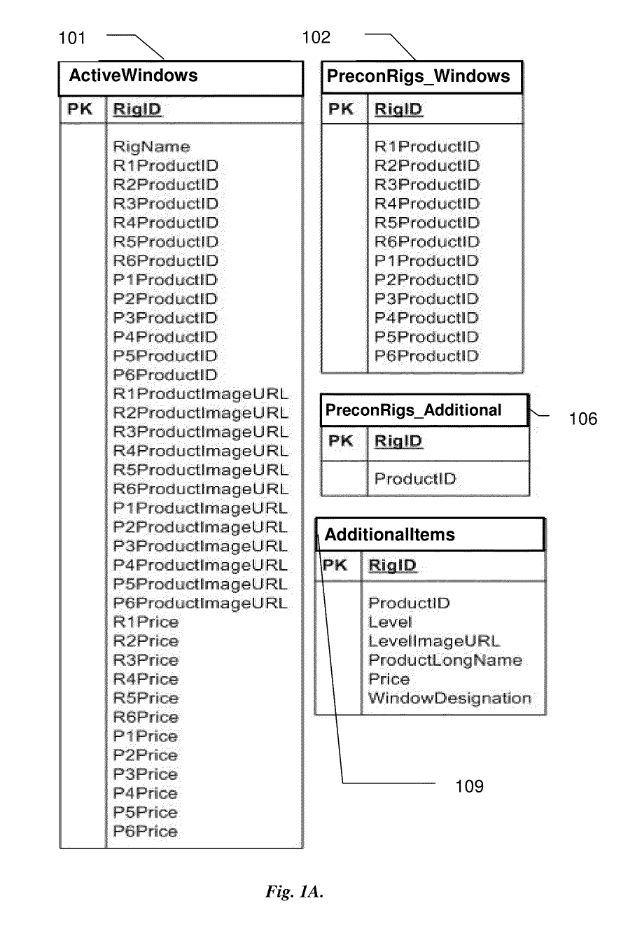

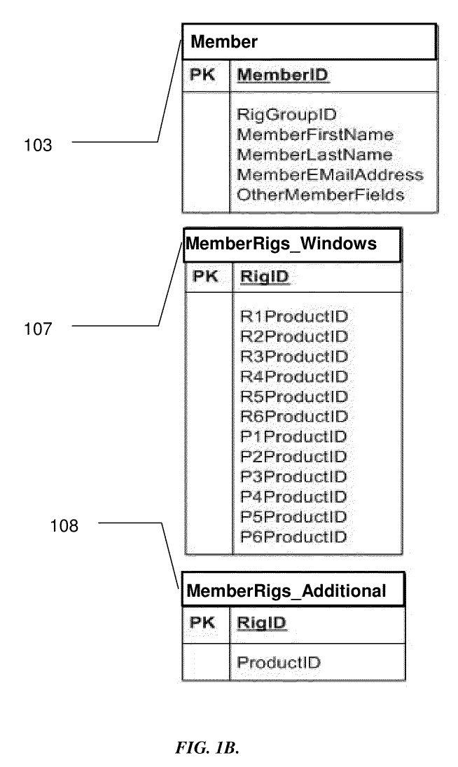

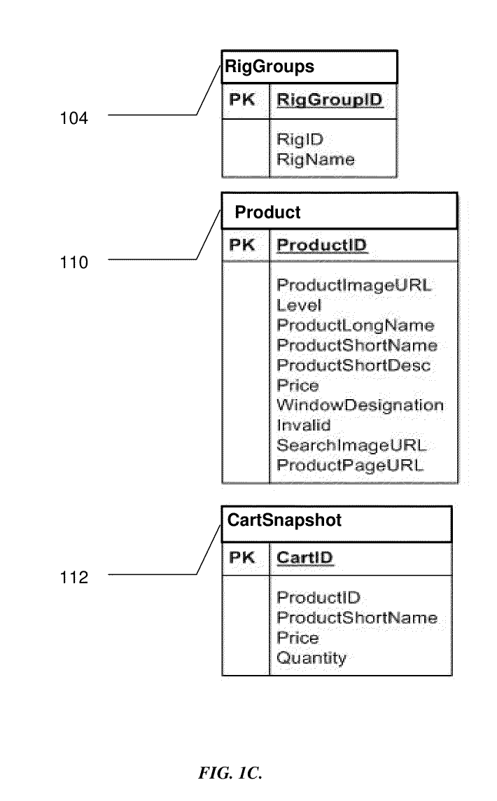

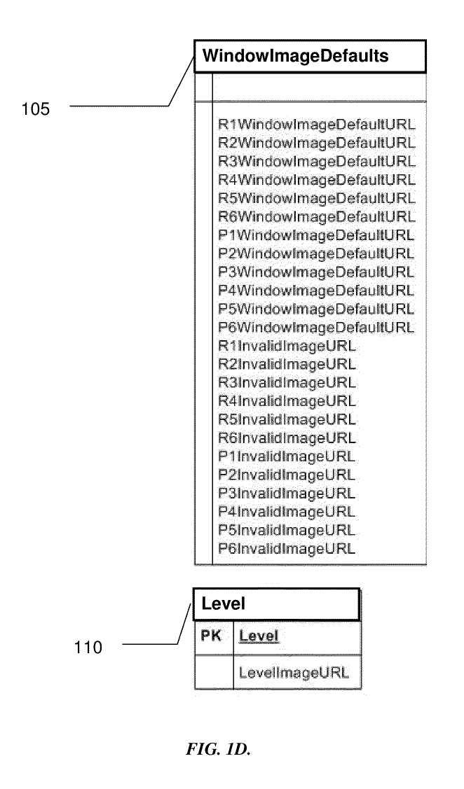

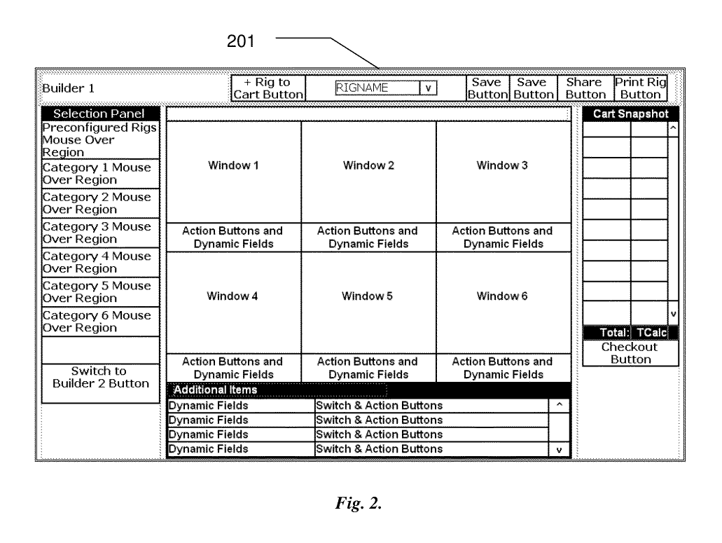

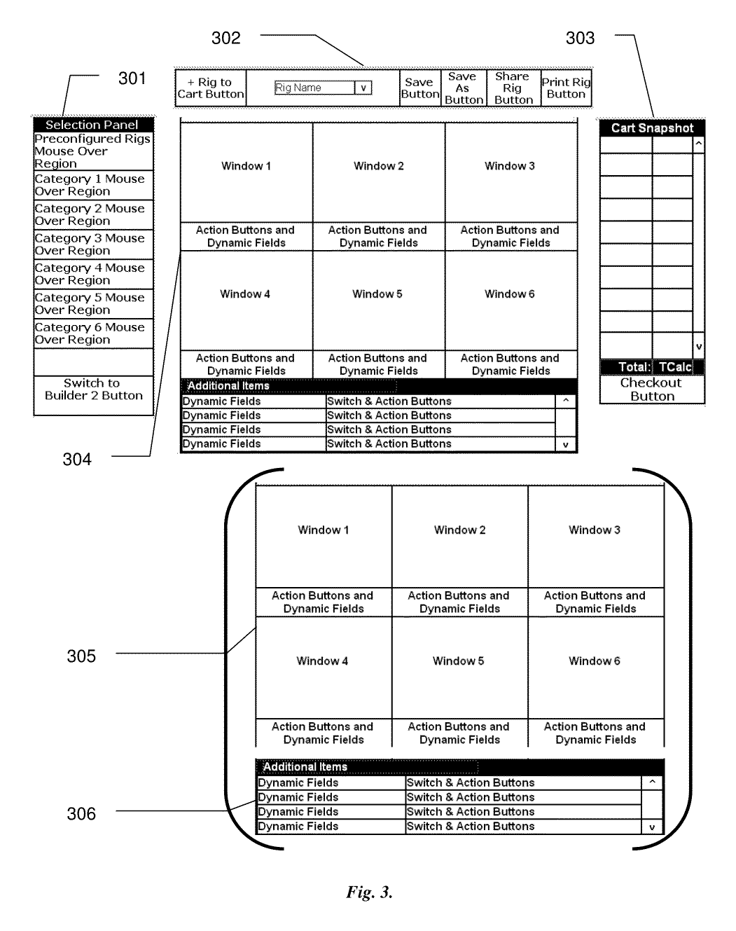

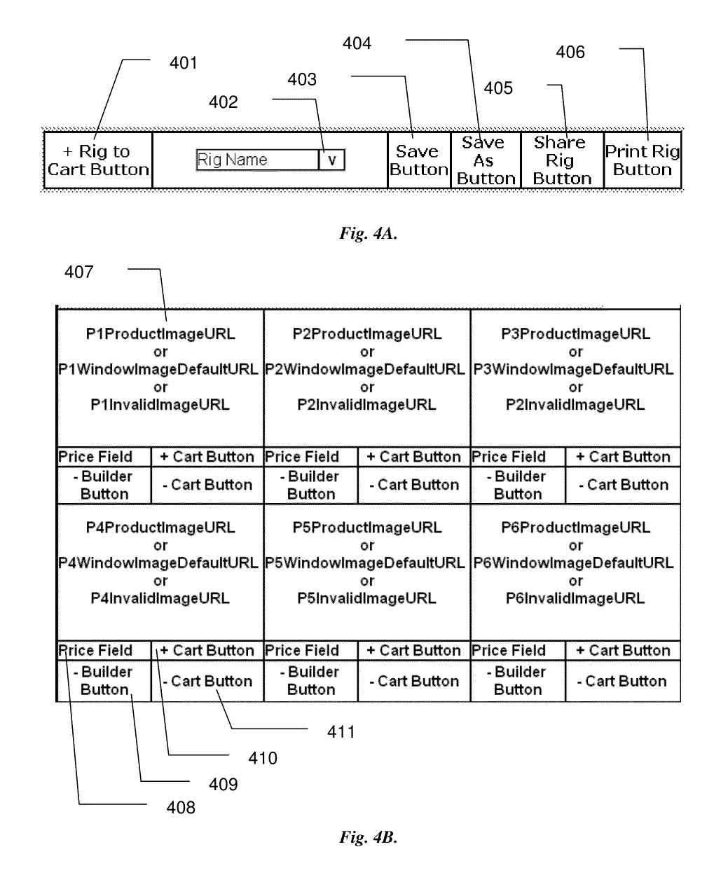

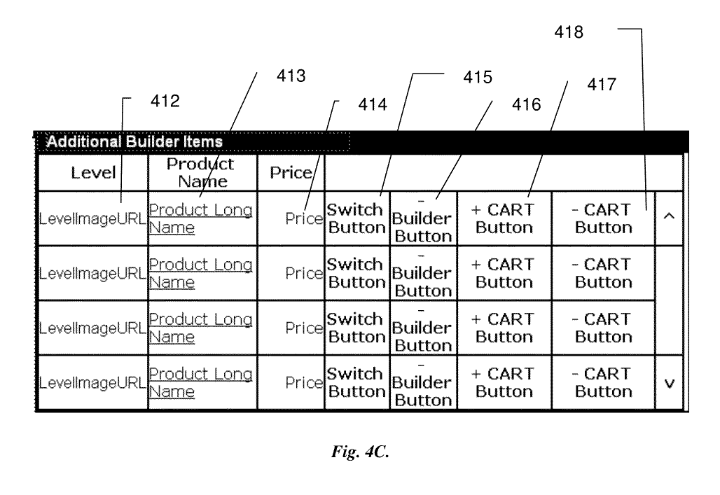

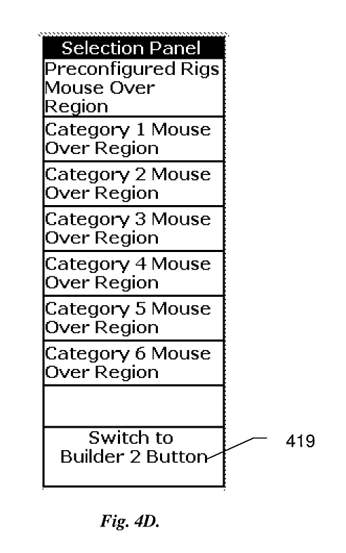

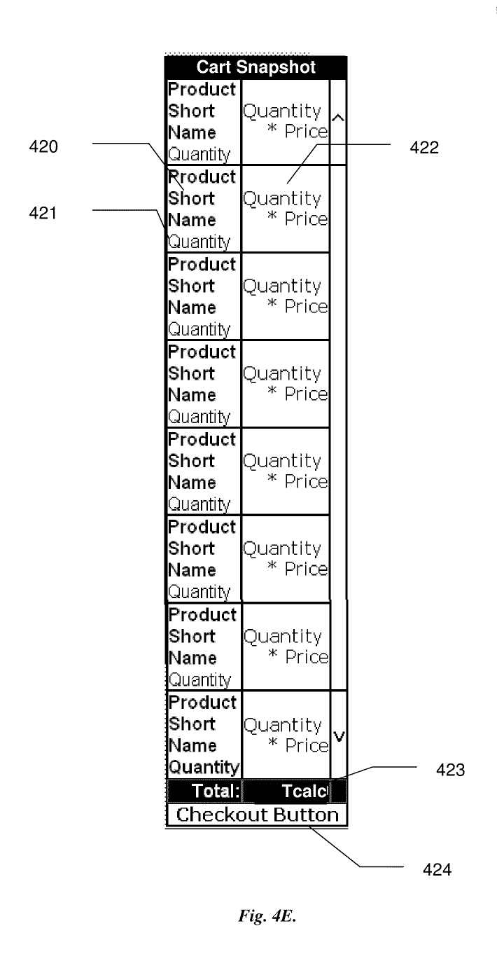

For the sake of brevity, conventional web pages dynamically linked to a back-end database via a connection protocol, application development, the programming language used to accomplish the connection protocol and other functional aspects of the systems (and components of the individual operating components of the systems) need not be described in detail herein as their are multiple options available to practice the invention. Furthermore, the database diagram, tables and fields shown in FIG. 1. and referenced throughout the detailed description herein are sufficient for those skilled in the art to practice the invention, but are intended to represent exemplary tables and fields, not the exact schema for practicing the invention. Therefore, it should be noted that alternative or additional tables, field names, functional relationships, or connections may be present in a practical system.

As will be better understood from the following description, the present invention is embodied at least in part in a web site, comprising of a collection of web pages, accessible via the Internet that have a dynamic connection to a back-end database. As is well known by those skilled in the art, the term “Internet” refers to the collection of networks and routers that use the transmission control protocol/Internet protocol (“TCP/IP”) or next generation protocols to communicate with one another. A back-end database is well known by those skilled in the art as consisting of a number of tables, fields within the tables and connections and relationships between the fields and tables. The dynamic connection to the back-end database is a protocol that links the back-end database to dynamic data entry regions, selection options, or data presentation areas on the web page. The web page will additionally contain buttons, mouse over regions, drop down boxes or similar components that generate an action. A critical determinant of uniqueness of the invention does not lie in the exact language of the protocol, as there are multiple variants of programming languages and syntax to practice the invention, but rather in the combination of builder display components and the associated logic in the query statements triggered by the buttons and similar components that allow the action to occur as intended to fulfill the method. Therefore the following description will outline the buttons and similar components, and their related logic. In simpler terms there are two key overarching criteria for the differentiation of this invention vs. previous related online pre-purchase methods:

1. The presentation of the combined various elements of the invention presents the user with the same or better abilities of standard existing online pre-purchase methods generally allowing for adding to the bundle, removing from the bundle, saving the bundle, sharing the bundle, sending a portion or the entire bundle to the shopping cart for checkout etc., but in an format that is entirely in the visible frame of reference to the typical user.

2. The presentation of the images in the invention is such that images are appositional analogous to a material world application that requires multiple items to accomplish (e.g. filming a movie, editing and mixing an audio recording, editing a movie, recording audio, etc.)

The following description outlines a method and claims that support this overarching criteria. As is standard in describing database fields, in the following descriptions a table field will be preceded by the table name, then a colon, then the field. For instance the field RigID in the AdditionalItems table 109 will be defined as AdditionalItems:RigID 109. In a statement where there are fields from two tables such as “update ActiveWindows:RigID=PreconRigs_Window” then the description will also contain the figure notations for each of the tables 101:102.

This invention provides for an improved online e-commerce pre-purchase “wish list” tool (a.k.a. “the builder”) using visual bundling. It uses a web page(s) displayed in a browser dynamically linked to a back-end database FIG. 1. that combines a pre-defined image window matrix 305, an additional builder items scrolling textual list 306, an expanding selection panel 301, a cart snapshot 303 and a control bar 302 for saving a rig 403, saving the rig as a new rig 404, sharing the rig 405, printing the rig 406 and moving the entire rig to the cart snapshot 401. The primary workspace for the user is the builder window 304 within which is the image window matrix 305 and the scrolling textual list 306. By combining these two components in the builder window 304, the invention provides a means for the typical user to be able to visualize all items in the bundle while keeping the builder in the visible area of a screen (a.k.a. “above the fold” of the screen.)

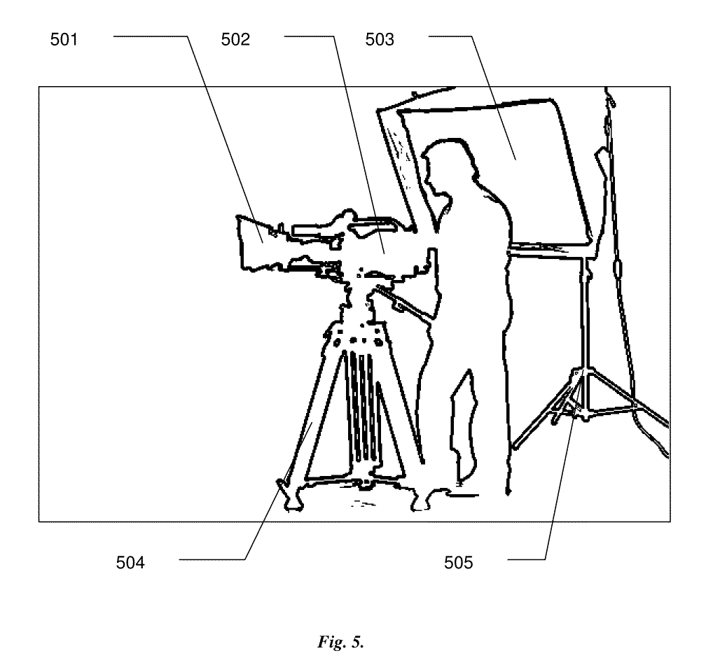

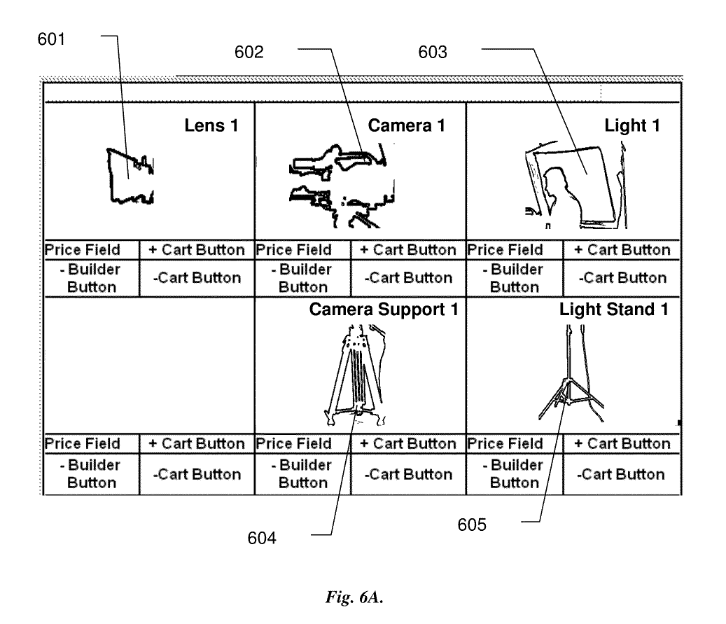

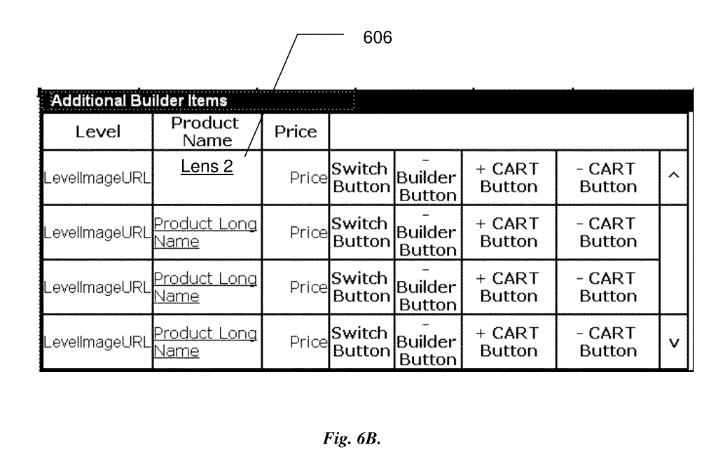

Additionally, the builder window 304 is populated by the user by selecting an item from the selection panel 301. As the images are associated in the back-end database FIG. 1. to a specific window, when multiple images are selected from different categories, the invention provides a means to build a bundle of goods that are appositional relating the bundle of goods in the builder to a material world analogue such as filming a scene FIG. 5. To film a scene a filmmaker typically requires a camera 502, lens 501, light and soft box 503, light stand 505 and a camera support tripod 504. When a user selects these items from their respective categories in the selection panel submenu 903, or from a preloaded menu option 805, 402, they appear in the image window matrix analogous to the material world application. For instance, by predefining lens images in Product:WindowDesignaton as R1 110, when the user selects a lens from the selection panel 905 then the image of the lens will populate the image window matrix window for which the image has been predefined. In this example the image will appear in the image window R1 407. Similarly, a camera would appear in R2 602, a light soft box in R3 603, a camera support tripod in R5 604 and a light stand in R6 605. Providing this visualization appositional analogous to the material world application vastly improves the users pre-purchase experience. To support the typical functionality of current “wish list” technologies, there are buttons to remove the item from the builder image window matrix 409, add the item to the cart snapshot 410, remove the item from the cart snapshot 411, and display the product price 408. As the product name is generally not dynamic, it can be embedded in the product image.

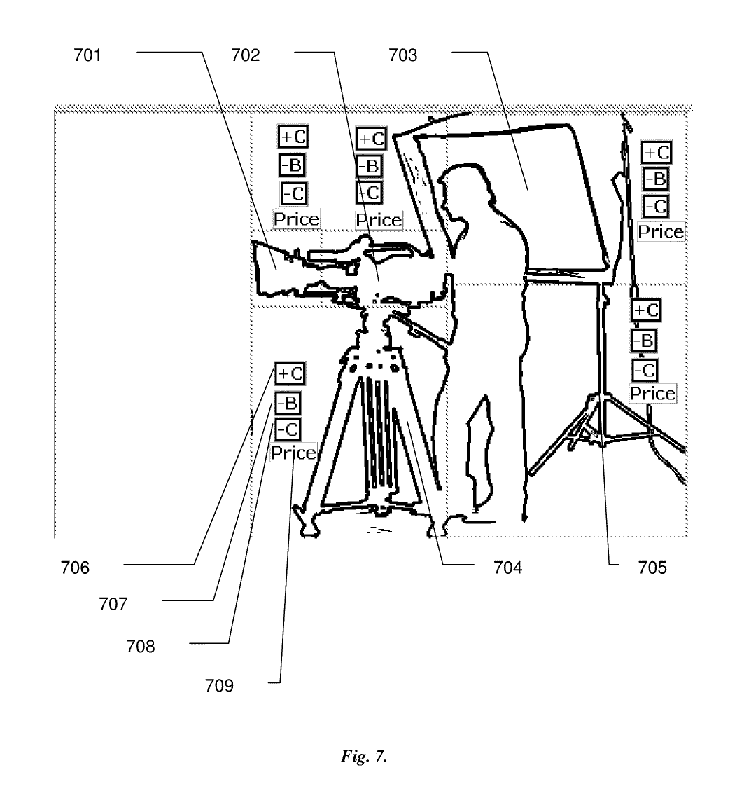

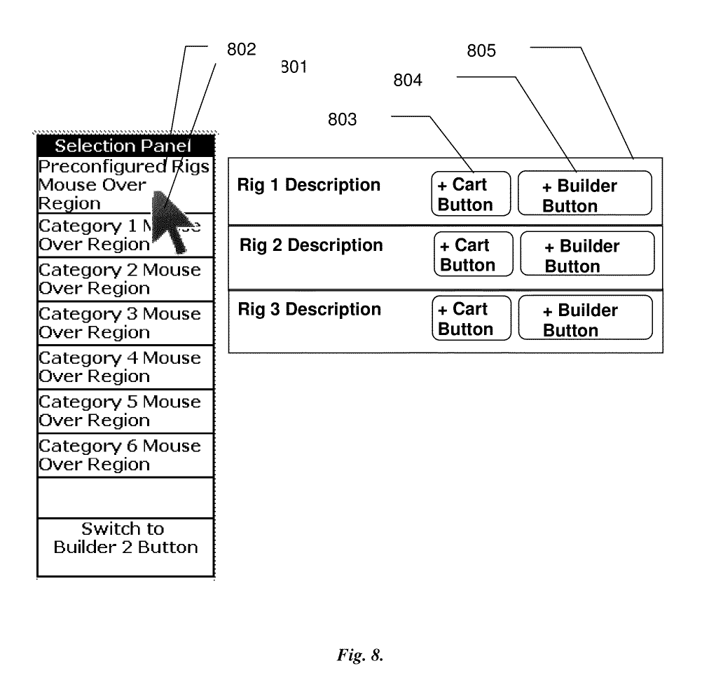

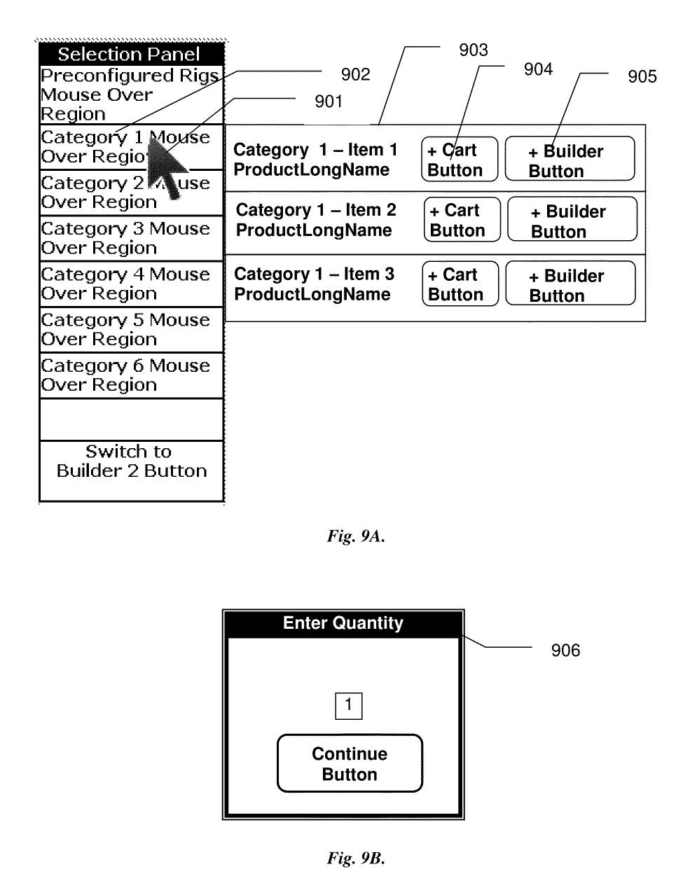

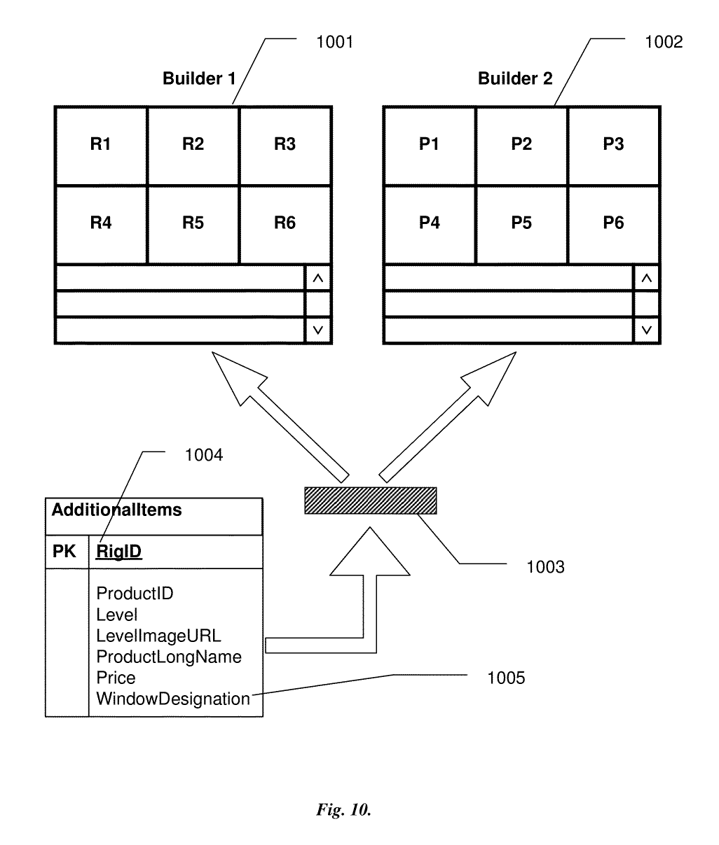

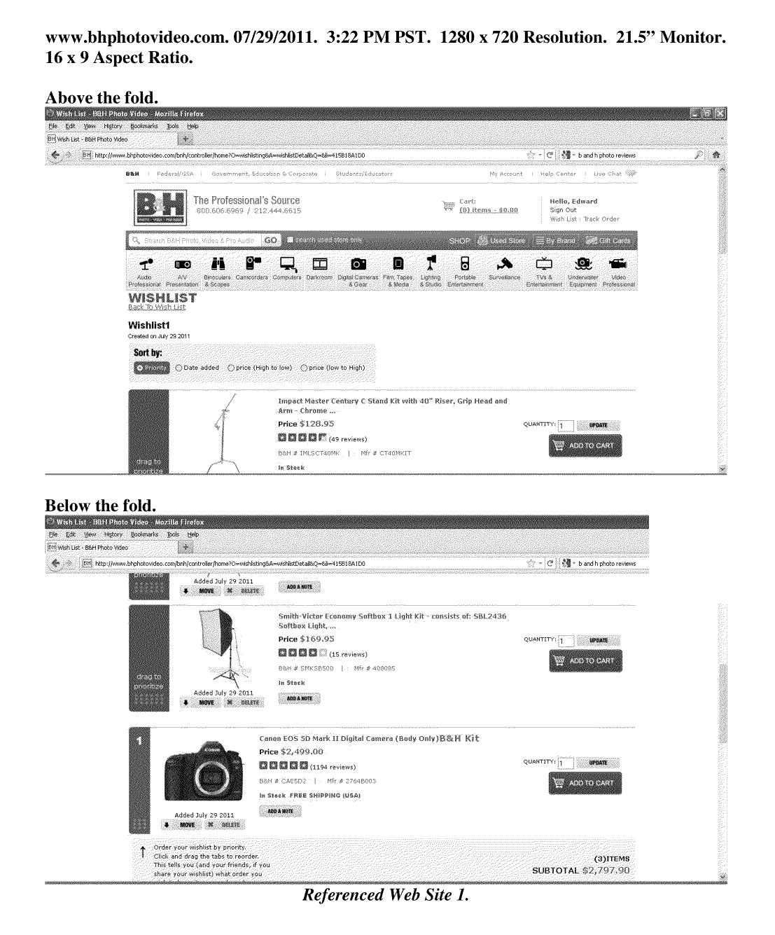

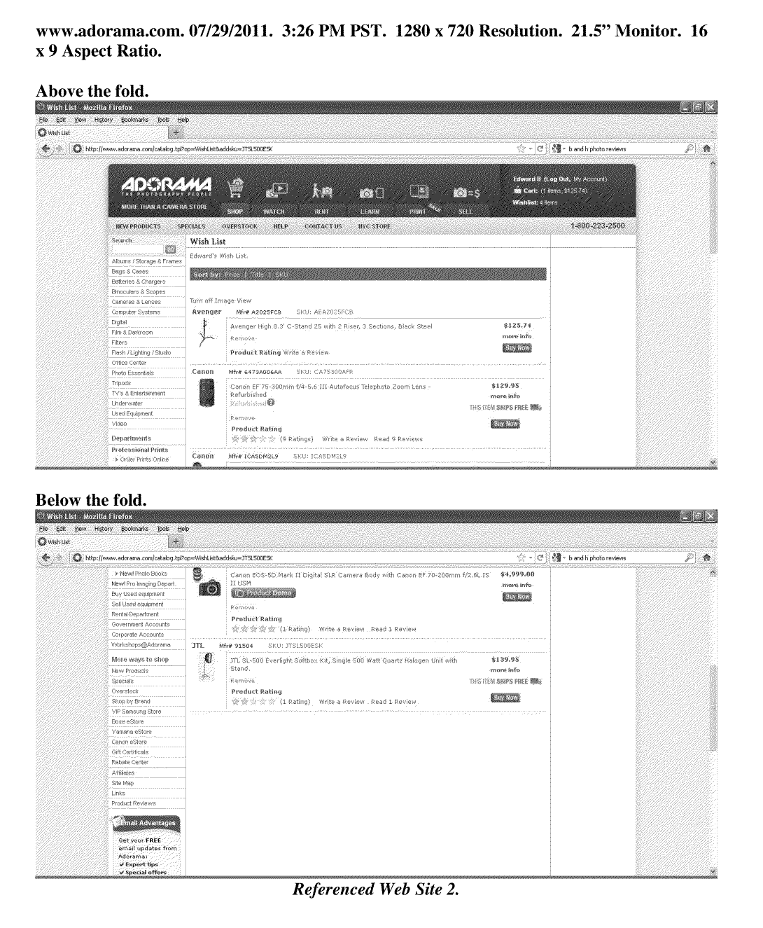

A variant of the image window matrix is to further add proportionality FIG. 7., thus additionally providing the size relationship of the items in the bundle to each other provided the images are shot and resized for the display in the same manner. This is accomplished in the invention by creating differently sized windows in the image window matrix using nested tables and cropping the item images for that proportion. For instance a camera lens with an attached matte box for holding filters 701 is approximately square and of the same height as a camera 702, which is longer and would fit in a rectangular window. A soft box for a light 703 is larger in proportion to the other items and a camera tripod 704 and light stand 705 are tall and fit in a rectangular window. By populating windows with images true to their actual proportion, the user benefits from an improved frame of reference. To accommodate the functionality generally available in a standard “wish list”, dynamic layers with icon buttons can be provided in proximity to the image to allow the user to add the item to the cart 706, remove the item from the builder 707, remove the item from the cart 708 and display the price dynamically 709.

As many material world applications have multiple related processes but contain sets of different items used to accomplish the processes. For instance a filmmaker filming a scene (i.e. “production”) may require a camera 502, lens 501, light and soft box 503, light stand 505 and a tripod 504 and when editing the scene (i.e. “post-production”) will require a computer, monitor and audio mixer. The invention therefore supports a means to create a superset of items (a.k.a. a “rig”) using two builders 1001 and 1002 with items linked by a singular key 1004, but with each builder containing items associated with the different process item bundles (e.g. a builder for visually bundling a set of items for production 1001 and a builder for visually bundling a set of items for post-production 1002. A button is provided on each builder to toggle to the other builders 419. As the back-end database FIG. 1. may use a single table to feed both builders 101, the display must filter 1003 items displayed in the scrolling textual list by filtering on some field such as AdditionalItems:WindowDesignation 1005. The window designations in the image window matrix 305 will also be different. Builder 1 1001 would have image window matrix designations R1 407 through R6 and builder 2 1002 would have image window matrix designations P1 through P6.

As the seller may wish to pre-configure a rig to provide a user with a rig best suited to their needs, or to give them a starting point to edit, one of the buttons in the selection panel 301 can contain a button for pre-configured rigs 802.

As previously stated, a critical determinant of uniqueness of the invention is the logic in the query statements triggered by the buttons and similar components that allow the action to occur as intended to fulfill the method. The following is the detail of the embodiments in the invention and the underlying query logic.

A user must be able to add an item to the builder window 304 and yet have the builder still remain in the visible portion of the screen. To accomplish this the user would hover (a.k.a. “mouse over”) their mouse pointer 901 over a category on the selection panel 902 thus opening an expanding submenu 903 that is a layered over the builder window 304. This expanding menu 903 contains a button 904 for simultaneously adding the item directly to the shopping cart snapshot 303 and to a window in the image window matrix 407. There is also a button 905 for adding the item just to a window in the image window matrix 407. If the user clicks the “add to builder” button 905 (a.k.a. “+Builder”) from the selection panel 902 for the first time and the Window Designation for that ProductID is R1 the following logic is executed: If ActiveWindows:R1ProductID 101 is null then ActiveWindows:ProductID=Product:ProductID 101:110 and ActiveWindows:R1ProductImageURL=Product:ProductImageURL 101:110 and ActiveWindows:R1Price=Product:Price 101:110. This will result as follows; The Window R1 407 displays the fields Product:ProductImageURL 110 and Product:Price 110.

If the user clicks the “Add to Builder” (a.k.a. “+Builder”) button from the expanding menu 903 and Product:WindowDesignation 110 for that ProductID is R1 and R1 is already occupied then the item will go into the additional builder items scrolling textual list 306. This allows all items in this builder to be included in the builder while keeping the builder in the visible portion of the screen. The following logic is executed: If ActiveWindows:R1ProductID 101 is not null then update ActiveWindows:R1ProductID 101 with new Product:ProductID 110 and update ActiveWindows:R1ProductImageURL=Product:ProductImageURL 101:110 and update ActiveWindows:R1Price=Product:Price 101:110. Update AdditionalItems:ProductID 101 with the old ActiveWindows:R1ProductID 101 and update other AdditionalItems 109 fields from the Product 110 and other related tables. This will result as follows; The newly selected product is displayed in the window image matrix 305 and the information from the product previously in that window is populated in the additional builder items component of the invention 306.

If the user has selected two items from the same category, they may want to view the second item image in the image window matrix. To facilitate switching images, the user can click the “Switch” button 415. If this was selected from the additional builder items 415 component for an item with Windows Designation=R1 then the following logic is executed: Update ActiveWindows:R1ProductID=AdditionalItems:ProductID 101:110 and update ActiveWindows:R1ProductImageURL=AddtionalItems:ProductImageURL 101:109 and ActiveWindows:R1Price=Product:Price 101:110. Update AdditionalItems:ProductID 109 with old ActiveWindows:R1ProductID 109 and update other AdditionalItems fields 412, 413,414 from the Product 110 and related tables. This will result as follows; the image in the R1 802 window switches with the item that was in the Additional Builder Items section 306. The additional builder items component 306 is populated with the information from the item that was previously in the R1 window 802.

As a means for saving the rig, the user clicks the “Save” button 403 in the control bar 302. If ActiveWindows:R1ProductID 101 to ActiveWindows:P6ProductID 101 and AdditonalItems:ProductID 109 is null then a small error message will pop over the center of the screen with “No items have been added to your Rig” The window should have a standard close button. If ActiveWindows:R1ProductID 101 to ActiveWindows:P6ProductID 101 and AdditonalItems:ProductID's 109 is not null then the user is forwarded to a standard registration process for sign in and brought back to the builder (this step is skipped if the user is already in a registration sign in state), after which a small window will pop over the center of the screen with “Overwrite ActiveWindows:RigName?” There should be a “Yes” button and a “Cancel” button. If the user clicks “Yes” then update MemberRigs:ProductIDStorageFields 107 with ActiveWindows:ProductID's 101 and AdditionalItems:ProductID's 109 and update Member:RigGroupID 103 with a new ID (or have this ID created at time of user record creation by default) and create a new record in the tables RigGroups 104, MemberRigs_Windows 107 and MemberRigs_Additional 108. This will result as follows; A user has updated the current rig with the new items.

As a means for creating a new rig from an existing displayed bundle, the user clicks the “Save As” button 404. If ActiveWindows:R1ProductID 101 to ActiveWindows:P6ProductID 101 is null then a small error message will pop over the center of the screen with “No items have been added to your Rig” The window should have a standard close button. If ActiveWindows:R1ProductID 101 to ActiveWindows:P6ProductID 101 and all AdditonalItems:ProductID's 109 is not null then a small window will pop over the center of the screen with “Name Your Rig” and a text box. There should be a “Save” button and a “Cancel” button. If the user clicks “Save” then create a new record in the table RigGroups 104 and update RigGroups:RigName 104 with the rig name from the pop window the text box and create a new record in the table MemberRigs_Windows 107 and MemberRigs_Additional 108. This will result as follows; A user has saved a new Rig with the current items.

As a means for sharing the rig with another user, the user clicks the “Share Rig” button 405. If ActiveWindows:R1ProductID 101 to ActiveWindows:P6ProductID 101 is null then a small error message will pop over the center of the screen with “No items have been added to your Rig.” The window should have a standard close button. If ActiveWindows:R1ProductID 101 to ActiveWindows:P6ProductID 101 and all AdditonalItems:ProductID's 109 is not null then a small window will pop over the center of the screen querying the user for an e-mail address and a send button. This will result in an e-mail being sent to the recipient with an identifying URL linking to the rig and opening the builder to the correct ActiveWindows:RigID 101 and AddtionalItems:RigID in the recipients browser.

As a means for the user to print the rig, the user clicks the “Print Rig” button 406. If ActiveWindows:R1ProductID 101 to ActiveWindows:P6ProductID 101 is null then a small error message will pop over the center of the screen with “No items have been added to your Rig” The window should have a standard close button. If ActiveWindows:R1ProductID 101 to ActiveWindows:P6ProductID 101 and all AdditonalItems:ProductID's 109 is not null then a new window slightly smaller than a full window will pop blank over the page populated with all images from the ActiveWindows table 101 and all the text from the Additional Builder Items table 109 along with a button for facilitating printing.

As a means for the user to add the items in the entire rig to the cart snapshot 303 a user clicks the “+Rig to Cart” button 401. A pop window will appear alerting the user to the opportunity to add additional quantities of individual items by clicking the “Add to Cart” button (a.k.a. “+Cart”) button 410, 417, 706 from the builder window. A “Continue” button will complete the user notification and process the action. This will copy ActiveWindows:ProductID's 101 to CartSnapshot:ProductID 112. All Additional CartSnapshot fields 112 are updated from the Product table 110.

As a means for moving individual items in the rig to the cart snapshot from a window in the image window matrix 410 the additional builder items scrolling text list 417, or the selection panel submenu 903, the user clicks the “Add to Cart” button (a.k.a. “+Cart”) button 410, 417, 706, 803. This action opens a quantity input pop window 906. The window defaults to 1. The user may change the quantity and click the “Continue” button, or not change the quantity and click the “Continue” button to keep the quantity to the default. Upon clicking the “Continue” button the action is processed and the ProductID associated to that window/layer from the ActiveWindows table 101, 706, the ProductID associated to that item selection in the selection panel 904, or the ProductID associated to that row from the AdditionalItems table 109 is appended to the CartSnapshot table 112. Other fields are updated in the CartSnapshot table 112 from the Product table 110 with the exception of CartSnapshot:Quantity 112. This field defaults to the quantity default of 1 or, if changed, the quantity entered in the quantity input pop window 906. Once processed CartSnapshot:ProductShortName 112 is presented in the cart snapshot invention component 420. The price field in the cart snapshot 422 is updated to CartSnapshot:Quantity*CartSnapshot:Price 112 and the cart snapshot total 422 field performs the Tcalc function updating the field to the sum of CartSnapshot:Quantity*CartSnapshot:Price 112 for all records in the CartSnapshot table 112.

As a means for the user to remove individual items from the cart snapshot, the user can click the corresponding “Remove from Cart” buttons (a.k.a. “−Cart) 411, 418. This action opens a quantity input pop window 906. The window defaults to 1. The user may change the quantity and click the “Continue” button, or click the “Continue” button to keep the quantity to the default. Upon clicking the “Continue” button the action is processed. The further logic is inverse to adding an item to the cart as specified above.

As means for the user to remove the item from the image window matrix 305 or the additional builder items scrolling textual list 306, the user can click the “Remove from Builder” button (a.k.a. “−Builder”) 409, 416, 707. For an item in Window R1 407 upon the user clicking the “Remove from Builder” button, then item is removed from the builder. If there is an item where AdditionalItems:WindowDesignation=R1 109 then ActiveWindows:R1ProductID, ActiveWindows:R1Price and ActiveWindows:R1ImageURL 101 is updated from AdditionalItems:ProductID, AdditionalItems:Price and Product:ProductImageURL 109. The item is then removed from AdditionalItems 109. If there is no item in AdditionalItems 109 where AdditionalItems:Window=R1 109, then the window will be populated with WindowImageDefaults:R1WindowImageDefaultURL 105. This will result as follows; A user has removed items from the builder. The image window matrix 305 and/or the additional builder items scrolling text box 306 is brought back to the default state.

As a means for a user to add an entire pre-configured rig, the user “mouses' over” 801 the “Preconfigured Rigs Mouse Over Region” 802 presenting the rig description submenu 805. Upon the user clicking the “Add to Builder” (a.k.a. “+Builder”) button 804. The tables ActiveWindows 101 and AdditionalItems 109 are then updated from PreconRigs_Windows 102 and PreconRigs_Additional 106.

As a means for a user to add a rig they have previously built and saved, the user in a registration signed in state can select one of their rigs from the drop down menu 402. The tables ActiveWindows 101 and AdditionalItems 109 will be updated from MemberRigs_Windows 107 and MemberRigs_Additional 108. Other fields in the ActiveWindows 101 and AdditionalItems 109 tables will be updated from the Product 110 table. An invalid product check is then performed where Product:Invalid=true 110 for ActiveWindows:ProductID's 101 then ActiveWindows:ProductImageURL=WindowImageDefaults:InvalidImageURL 101:105. Additionally, an invalid product check is performed where Product:Invalid=true 110 for AdditionalItems:ProductID's 109. If Product:Invalid=true 110 for AdditionalItems:ProductID 109 then AdditionalItems:ProductLongName=“Product:ProductShortName” & “No Longer Valid, Remove from Builder ProductLongName” 109 and AdditionalItems:Price 109 is overwritten to $0.00. This will result as follows; The user is notified in the that they need to replace the invalid product and they cannot be charged for an invalid item.

As a means for a user to add a new user rig, the user the user in a registration signed in state adds a new rig name to the rig name drop down menu 402 and clicks the “Save” button. This creates a new RigID in the MemberRigs_Windows 107 the MemberRigs_Additional 108 and the RigGroups 104 tables. and updates MemberRigs_Windows 107=ActiveWindows Windows 101 for all like fields, updates MemberRigs_Additiona 108=Additonal Items 109, saves RigGroups:RigName 104=to the name in the rig name drop down menu 402, associating that RigName 104 in the RigGroups table to the new RigID created. This will result as follows; The user has named and saved a new user generated rig.

As a means for a user to proceed to the check out process for purchasing products, the user can click the checkout button 225. An invalid product check is then performed where Product:Invalid=true 110 for CartSnapshot:ProductID's 112. If Product:Invalid=true 110 then CartSnapshot:ProductShortName=“Invalid” & “Product:ProductShortName” 112 and CartSnapshot:Quantity 421 is set to $0.00. The cart snapshot price fields 422 and the cart snapshot total field 225 is recalculated. This will result as follows; The user is notified that they need to replace the invalid product and they cannot be charged for an invalid item. If Product:Invalid=false 110 then the CartSnapshot fields 112 are ported to the back-end database behind the checkout purchase tool for further processing.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A computer implemented system for online pre-purchase visual bundling of items for purchase comprising:
an online display of items for purchase:
a predefined image window matrix;
a scrolling textual list;
an expanding selection panel;
a cart snapshot; and,
a control bar adapted for selecting items for purchase to form a bundle of selected items, building, editing, saving, sharing, printing images representative of said chosen ones of said items, and purchasing said bundle.

2. A computer implemented method for relating the pre-purchase bundle of items for purchase to a material world appositional analogue comprising:
providing an online display of items for purchase:
providing a predefined image window matrix;
providing a scrolling textual list;
providing an expanding selection panel;
providing a cart snapshot;
providing a control bar adapted for selecting items for purchase to form a bundle of selected items;
predefining an image window designation to an image for a product and populating the designated window image into the corresponding window image matrix window with said bundle of items;
building, editing, saving, sharing and/or printing images representative of said bundle of items;
purchasing said bundle of items; and,

3. The computer implemented method of claim 2 further
providing an “above the fold” visualization and list of said bundle of items by providing an appositional image window matrix combined with a scrolling textual list.

4. The computer implemented method of claim 2 including switching items for purchase from the scrolling textual list to the image window matrix;

5. The computer implemented system of claim 1 including multiple builders linked via a singular key to creating a superset of items for purchase.

6. The computer implemented system of claim 1 further adapted for moving a selected item to the shopping cart snapshot, removing the selected item from the shopping cart snapshot and removing the selected item from the builder windows.

7. The computer implemented system of claim 1 further adapted for moving a selected item to the shopping cart snapshot, removing the selected item from the shopping cart snapshot and removing the selected item from the from the scrolling text list.

8. The computer implemented system of claim 1 further adapted for adding a predefined bundle of items for purchase to the image window matrix and adding to the scrolling text list a number of predefined item bundles from a submenu of the selection panel.
